(19) United States
(12) Patent Application Publication
(10) Pub. No.: US 2024/0060873 A1
(43) Pub. Date: Feb. 22, 2024

(54) OPTICAL ANALYSIS DEVICE FOR DETERMINING A CHARACTERISTIC OF A MEDIUM, HOUSING, AND SYSTEM

(71) Applicant: iSud Solutions GmbH, Eschach (DE)

(72) Inventor: Joachim Mannhardt, Eschach (DE)

(21) Appl. No.: 18/382,047

(22) Filed: Oct. 19, 2023

Related U.S. Application Data
(63) Continuation of application No. PCT/EP2022/059998, filed on Apr. 14, 2022.

(30) Foreign Application Priority Data
Apr. 19, 2021 (DE) 10 2021 109 748.7

(51) Int. Cl. G01N 21/01; G01N 21/31

(52) U.S. Cl. CPC G01N 21/01; G01N 21/31; G01N 2201/022; G01N 2201/127; G01N 2201/023

(57) ABSTRACT

An optical analysis device for determining at least one characteristic of a medium in a process environment or a laboratory environment is provided. The optical analysis device includes an optical measuring arrangement with a plurality of components arranged in an interior space of a housing. The housing has at least one entry/exit area for the entry and/or exit of optical radiation, and a mechanical interface for a positionally accurate detachable attachment of the optical analysis device to a location of operation, in particular in a process environment. Advantageously, the mechanical interface spatially overlaps with the optical radiation entry/exit area. This enables fast assembly and disassembly of the optical analysis device in different locations of use.

### CROSS REFERENCE TO RELATED APPLICATIONS

This application is a continuation application of international patent application PCT/EP2022/059998, filed Apr. 14, 2022, designating the United States and claiming priority to German application 10 2021 109 748,7, filed Apr. 19, 2021, and the entire content of both applications is incorporated herein by reference.

### TECHNICAL FIELD

The disclosure relates to an optical analysis device for determining a characteristic of a medium. Furthermore, the disclosure relates to a housing for components of a measuring arrangement for an optical determination of a characteristic of a medium. Finally, the disclosure relates to a system including an optical analysis device and a calibration device.

### BACKGROUND

In many areas of the manufacturing and processing industry, optical measuring methods are utilized to evaluate the condition or quality of a product or an intermediate product. Hereinafter, the term “optical measuring method” is to be understood as a measuring method utilizing electromagnetic radiation, in particular electromagnetic radiation in a spectral range between infrared and ultraviolet. “Optical measurement” thus includes in particular a measurement in the spectral ranges far infrared (FIR), mid infrared (MIR), near infrared (NIR), in the visible spectral range as well as in the UV range.

In the chemical and pharmaceutical industries, and in food production, optical, in particular spectroscopic, analysis systems are used to perform in-process measurements of a measurand or measurable characteristic of a measurement medium that can be detected by optical means in a production environment with a probe or measuring cell. For example, an immersion probe can be provided which is immersed in the measurement medium located inside a reaction vessel or a tube. A measuring beam emitted by a radiation source is guided with the immersion probe over a measuring section through the measuring medium and then directed onto a detector in which the intensity, spectrum, etc., of the measuring radiation changed by the measuring medium are analyzed. The results provide information about state variables (e.g., concentration, density, etc.) of the measurement medium. The measurement medium can be a fluid and also a bulk material such as a powder or a gas. However, the measurement medium is not limited thereto.

A measuring arrangement suitable for such measurements includes a radiation source, a detector, and a controller, which are arranged together in a housing. If the optical analysis system is to be used in a process environment, the housing surrounding the measurement arrangement must be robustly designed to protect the measurement arrangement against temperature influences, dirt, dust, vibrations, etc. A measuring arrangement with such a housing is known from DE 10 2012 019 433 A1. A sensor device and an electronic device spatially separated therefrom are arranged in the interior of the housing. A cooling device is provided for temperature stabilization of the optical and electronic components located in the housing.

To ensure high measurement accuracy and reproducibility of the optical analysis system, regular validation using standards must be performed. Such validation typically takes place in a laboratory environment with a calibration device. If the optical analysis setup is integrated in a process environment during operation (i.e., permanently connected to the process), such validation involves considerable effort because the optical analysis system must be removed from the process environment and then reassembled in the process environment in the exact position after validation has been completed.

### SUMMARY

It is an object of the present disclosure is to provide an optical analysis device which can be used in a variety of measurement environments, and which can be quickly and accurately mounted in these measurement environments. Furthermore, a housing for an optical analysis device is provided which can be used as a universal housing for a wide range of different measurement arrangements and measurement environments. In particular, the housing is configured to ensure reliable mounting of different measurement arrangements tailored to the respective measurement or testing task, as well as good temperature stability. Finally, a system is provided which enables fast and simple validation of an optical analysis device used in a process environment.

The object is achieved by an optical analysis device, a housing for components of a measuring arrangement, and a system for determining at least one characteristic of a medium in a process chamber, as described herein.

The optical analysis device according to an aspect of the disclosure includes an optical measuring arrangement with several optical, electronic, electro-optical and/or electromechanical components which are arranged together in the interior of a housing. An entry/exit area is provided in the housing, in which electromagnetic radiation can exit the housing or enter the housing. For positionally accurate detachable mounting of the optical analysis device at a place of use, in particular in a process environment, the housing further includes a mechanical interface. With this mechanical interface, the optical analysis device can be attached in a reproducible manner at one or different locations of operation or use. For example, the optical analysis device can be attached in a predetermined position and orientation at a selected location in the process environment in order to measure a characteristic of a measurement medium at this location. On the other hand, the optical analysis device can be attached to a calibration device in a laboratory environment using this mechanical interface to perform validation of the optical analysis device. Fastening means to allow the housing with the measuring arrangement contained therein to be mounted in the process environment in a manner that is resistant to rotation and displacement. On the other hand, this fastening is detachable, such that the housing with the measuring arrangement contained therein can be removed from the process environment and transferred to another location without much effort. In particular, the housing can be removed from the process environment, e.g., in the course of a regular check of the measuring arrangement—and transferred to a calibration station where, e.g., with standard cuvettes, a calibration or validation of the measuring arrangement is performed. Afterwards, the measuring arrangement can be transferred back to its place of use in the process environment and mounted in the correct position with the fastening means provided on the housing.

The optical, electronic, electro-optical and/or electromechanical components required to perform a given measurement task are advantageously arranged together on a component carrier in the interior of the housing. The type, number and positioning of the components mounted on the component carrier varies depending on the measurement or testing task. For example, for spectrometric determination of a characteristic of a medium, e.g., a fluid contained in a container, (at least) one radiation source, (at least) one detector unit for detecting a measurement radiation, and measurement electronics for recording and further processing the output data of the detector unit are provided on the component carrier. In addition, further components may be provided.

The fact that the components of the measuring arrangement are fixed together on a component carrier ensures stable alignment of the individual components with respect to each other. Fixing all components and assemblies on the component carrier also ensures that sensitive assemblies (for example, an optical bench with light guides) are protected against unintentional relative movements.

The component carrier can be detachably arranged in the interior of the housing such that the component carrier can be easily removed from the interior of the housing without great effort. This enables the optical and electronic components to be replaced quickly in the event of a repair. Furthermore, there is the advantage that the housing can be used for different measurement tasks: For example, if the optical analysis device is to be re-equipped from a first to a second measurement task, the component carrier configured for the first measurement task is removed from the housing and replaced by a component carrier configured for the second measurement task.

The measuring arrangement fixed on the component carrier is configured to perform a specific measuring task, while the housing can be used for a variety of different measuring tasks. The housing is thus a universal housing in the sense that when the measuring task is changed, only the corresponding component carrier needs to be replaced, while the housing as such remains unchanged. By replacing the component carrier, a measuring system can thus be quickly re-equipped to a new measuring task. Furthermore, one and the same housing can be used in different measuring environments or measuring points, provided that fastening means for the mechanical interface of the housing are provided at these measuring points. This results in several advantages:

An advantage for the manufacturer of measuring systems is that one and the same type of housing can be used for a wide range of optical analysis devices. It is therefore no longer necessary to configure and build a suitable housing for each new measuring task, but a universal housing is available in which the component carrier, adapted to the individual case and equipped with the components required in each case, can be inserted. Due to the mechanical interface provided on the housing, this universal housing can also be used in different measuring environments by providing suitable mounting elements for the respective measuring task.

For the user of the measuring system, there is the additional advantage of a modular system for optical analysis devices with a housing that can be attached to a variety of measuring points with the mechanical interface. Thus, in a process environment where different optical measurements need to be performed at many locations, appropriately configured mounting areas can be defined where the optical analysis devices can be mounted with the mechanical interface. If a defect occurs in one of the measurement systems, the defective analysis device can be quickly removed from the production environment and replaced with a replacement device without the need for costly adjustment. Alternatively, a defective component carrier can be removed from the housing and replaced with a functional component carrier.

Alternatively or in addition to the use of a component carrier, the housing itself may also have mechanical coding as described above for receiving and replacing individual components.

A housing according to an aspect of the disclosure includes a component carrier on which a measurement arrangement including a plurality of optical, electronic, electro-optical and/or electromechanical components can be mounted. Furthermore, the housing includes an entry/exit area for the entry/exit of optical radiation and a mechanical interface with which the housing can be fixed in a positionally accurate but easily and quickly detachable manner to a place of use, in particular to an outer wall of a process room or to a calibration device.

The mechanical interface includes fastening means, of which (at least) one is fastened to the housing and (at least) one is fastened to the place of use. In this context, the term “fastened” is intended to be understood to mean any force-fit, form-fit or material-fit, such that, for example, the fastening means provided on the housing can be welded, screwed or even formed integrally with the housing. The first fastening means provided on the housing and the second fastening means fastened at the point of use engage with each other in the installed position of the housing at the point of use in such a way that a mechanically stable, displacement- and torsion-proof, easily detachable connection with a clear orientation is produced.

If the housing is to be used at different locations, then a second fastening means can be provided at each of these locations, in which the first fastening means provided on the housing engages, to represent a fixed, positionally accurate detachable connection. In this way, a mechanical universal interface is created which, on the one hand, enables a rapid change of locations of use of the housing, and, on the other hand, also enables a rapid exchange of differently equipped or designed housings at the location of operation, provided that each of these housings is provided with a corresponding first fastening means.

In particular, one and the same housing can be used for measurement tasks in a process environment and a laboratory environment. This allows automated validation of the measurement assembly mounted in the housing, because the housing can be alternately attached to the measurement point in the process environment and to a validation assembly in the laboratory environment without having to open the housing or change the measurement assembly contained therein. In this way, a tidy and orderly optical analysis system is created in which the housing is a universal housing; however, the mounting of the component carrier contained within it can be quite different depending on the spectral range in which one is working.

A bayonet mount is particularly suitable for the positionally accurate detachable fastening of the housing at the point of use. A bayonet mount is a quick and easy connection of two cylindrical parts, whereby the parts are connected and disconnected by inserting them into each other and turning them in opposite directions. In this way, the measuring arrangement contained in the housing can be quickly and securely mounted and dismounted in its place of use, e.g., in a production environment.

Advantageously, the mechanical interface is configured such that the mechanical connection area of the housing spatially overlaps with the optical radiation entry/exit area. The exit area for optical radiation is thus located in the immediate vicinity of the fastening element or within the fastening element with which the housing is mechanically fixed in a process or laboratory environment. In this way, in addition to the positionally accurate mechanical connection, a positionally accurate optical connection of the measuring arrangement contained in the housing to the medium to be measured in the process space can also be ensured. The connection area can be configured such that when the housing is mechanically fixed at the point of use, not only is the highly accurate positioning of the housing ensured, but at the same time an optical coupling of the measuring arrangement mounted in the housing to the medium to be measured, for example a fluid flowing through a process chamber, is also ensured. If in this way, together with the establishment of the mechanical connection, a highly accurate alignment of the radiation exiting or entering the housing with respect to the medium to be measured at the point of use is also carried out at the same time, no additional adjustment of the measuring optics is necessary after the optical analysis device has been mounted at its point of use. The spatial overlap of the mechanical connection area with the optical entry/exit area thus simplifies the assembly and disassembly of the measuring system in the production environment to a considerable extent.

The spatial overlap of the entry/exit area for optical radiation with the mechanical interface not only integrates the optical interface into the mechanical interface, with which a positionally secure and quickly detachable connection of the housing at the point of use is established. More generally, an integration of all interfaces (mechanical, optical, thermal) in one and the same area can be achieved. This allows the optical analysis device to be connected both at a point of use in a process environment and in a laboratory environment for calibration. Any detachable form-fit and/or force-fit connection technique, for example a screw, plug-in and/or clamp connection, can be selected. A combined screw/plug-in connection in the form of a bayonet mount has proven to be particularly advantageous.

As described, the housing according to an aspect of the disclosure is suitable for use in a wide range of measuring and testing environments, in particular also for use in a harsh production environment. To protect the measuring arrangement from environmental influences, the interior of the housing is advantageously a closed cavity in which the component carrier and the optical components to be mounted thereon are completely accommodated. The optical measuring arrangement is thus completely enclosed by the walls of the housing and shielded from external contamination, contact, extraneous light, etc.

In an exemplary embodiment of the disclosure, the housing is configured as two parts, and includes an upper shell and a lower shell which can be connected to each other with a detachable connection, for example a screw connection.

If the measuring system is to be used in a process environment, it is recommended to provide a seal, for example a sealing ring or a flat seal, in a contact surface between the upper and lower shells. This ensures that dust and contaminants from the process environment are kept out of the interior of the housing.

Furthermore, it is advantageous if the housing is provided with a cooling and/or heating device for tempering the measuring arrangement contained in the interior of the housing. Many optical and electronic components require a constant temperature to operate stably. If very high or very low temperatures and/or temperature fluctuations prevail in the process environment in which the optical analysis device is to be used, suitable measures must be taken to effectively dissipate the heating or cooling currents applied to the housing from outside and thus ensure a constant temperature in the interior of the housing. Furthermore, heat generated by the optical and electronic components in the interior must be dissipated in a suitable manner.

The cooling or heating device is expediently located directly below the component carrier, for example in a cavity formed between the component carrier and a base plate of the housing in the housing interior. This enables effective temperature control of the interior of the housing over a large area. Cooling lines through which an externally supplied cooling medium flows are provided for temperature control. The density and arrangement of the cooling lines can then be adapted or varied according to the expected external thermal load or the temperature distribution in the interior of the housing. With such a cooling device, harmful temperature influences can thus be kept away from the interior of the housing during use of the optical analysis device, or at least controlled, and a temperature control of the electronic components can be achieved.

In this context, in an exemplary embodiment of the disclosure, the cooling or heating device can be configured such that a cooling medium, in particular a cooling liquid, first reaches at least one of the components, in particular an electronic component such as a processor, and subsequently reaches the entry/exit area for the entry/exit of optical radiation.

To facilitate assembly or configuration changes to the component carrier and replacement of the optical and electronic components mounted on it, the component carrier advantageously includes a drawing or mechanical coding that ensures unambiguous placement and alignment of the components at defined locations on the component carrier. This increases serviceability, since when a particular component is replaced, it is specified with high precision where and in what orientation the replacement component is to be positioned. Each individual (optical and electronic) component has its fixed master location, such that mix-ups or incorrect installation are avoided. This increases the ease of servicing and reduces the effort involved in equipping the component carrier for a given measurement task.

A complete system according to an aspect of the disclosure includes an optical analysis device, with which a characteristic of a medium in a process environment can be determined, and a calibration device for validation/calibration of this optical analysis device. A mechanical interface is provided between the optical analysis device and the calibration device, which corresponds to the mechanical interface between the optical analysis device in the process environment. Thus, the optical analysis device can be selectively connected either to a measuring point in the production environment or to the calibration device using one and the same mechanical interface. If the entry/exit area for radiation overlaps with the mechanical interface, the optical connection of the optical analysis device to the place of measurement in the process environment or to the calibration device can also be established at the same time. Since the mechanical interface permits an easily and quickly detachable, positionally accurate connection of the components, it is thus possible in a simple manner to remove the optical analysis system from the measurement location, validate it using the calibration device, and immediately reattach it to the measurement location. In contrast to conventional measuring situations, in which the optical measuring system is permanently installed in the production environment, the disclosure thus makes it possible to validate an optical measuring system used in a process environment in a simple manner. This thus enables simple, regular validation of an optical measuring system located in the process environment using traceable standards contained in the calibration device.

### BRIEF DESCRIPTION OF THE DRAWINGS

The invention will now be described with reference to the drawings wherein:

FIG. 1 shows a perspective view of an optical analysis device with a measuring arrangement accommodated in a housing according to an exemplary embodiment of the disclosure;

FIG. 2 shows a schematic sectional view of the housing shown in FIG. 1;

FIG. 3 shows a perspective view of a lower shell of the housing shown in FIG. 1 equipped with components;

FIG. 4 shows a perspective view of a lower shell of the housing shown in FIG. 1 equipped with other components;

FIG. 5A shows a perspective view of the optical analysis device shown in FIG. 1 in assembled position with an immersion probe for use in a process environment;

FIG. 5B shows a perspective exploded view of an assembly of the optical analysis device shown in FIG. 1 with a connection component;

FIG. 6A shows a detailed perspective view of a mechanical interface with a fastening element and a counter element for providing a bayonet mount;

FIG. 6B shows a detailed perspective view of the fastening and counter element shown in FIG. 6A;

FIG. 7A shows a perspective view of the optical analysis device shown in FIG. 1 in an assembled position with a calibration device;

FIG. 7B shows a schematic representation of a turntable loaded with specimens used in the calibration device shown in FIG. 7A;

FIG. 8 shows a detail of the sealing concept of the analysis device according to an exemplary embodiment of the disclosure;

FIG. 9 shows a further detail of the sealing concept; and

FIG. 10 shows a variant of the sealing concept.

### DESCRIPTION OF EXEMPLARY EMBODIMENTS

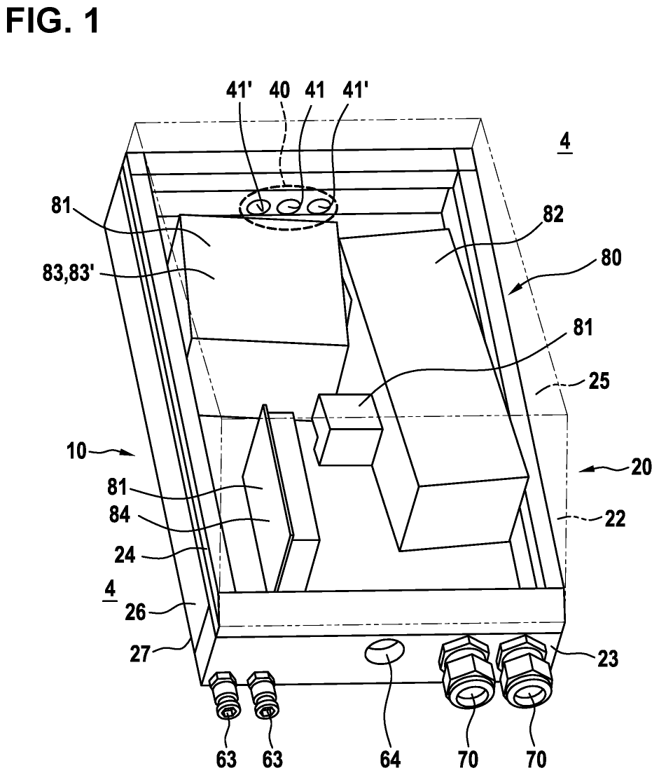

FIG. 1 shows a perspective view of an optical analysis device 10 for determining at least one characteristic of a measurement medium with an optical measurement method. The optical analysis device 10 includes a housing 20 in which a measuring arrangement 80 with a plurality of components 81 is accommodated. In particular, the measuring arrangement 80 includes a radiation source 82, a detector 83 (in the present case a spectrometer 83′) and a controller 84, and may also include further optical, electronic, electro-optical and/or electromechanical components 81. The controller 84 serves, among other things, to coordinate the timing between the spectrometer 83′ and the radiation source 82, in particular when a flash lamp is used or in pulsed operation. Furthermore, the controller 84 can be used to open or close a shutter (not shown in the FIGS.) or to perform an internal auto-calibration. The controller 84 can also take over further control and evaluation functions, e.g., the calculation of a spectrum or a process parameter from the signals of the spectrometer 83′ and the forwarding of measurement results, for example via Ethernet or a process interface, to an external space 4 located outside the housing 20.

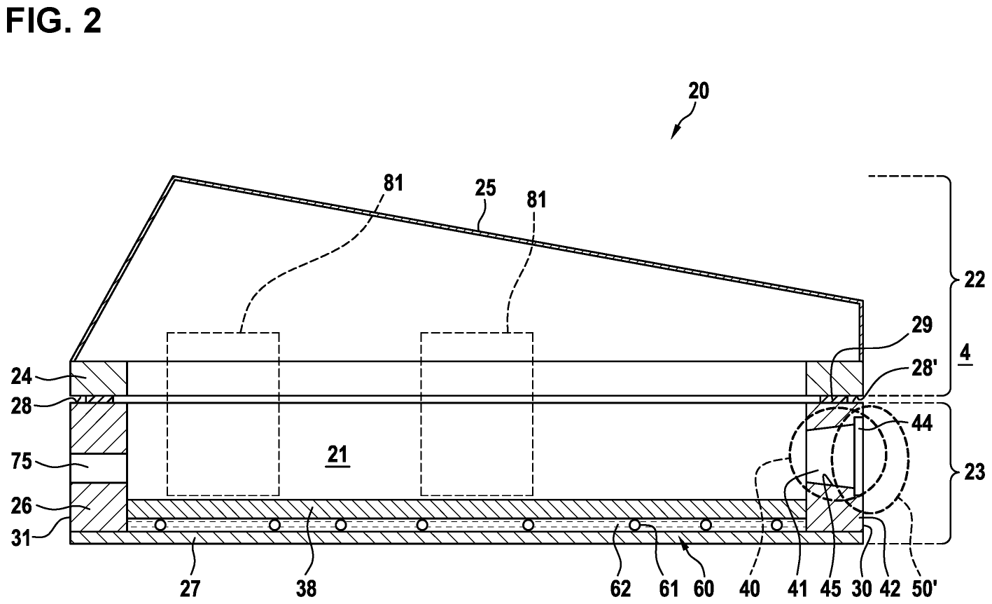

FIG. 2 shows a schematic sectional view of the housing 20 shown in FIG. 1. The housing 20 has a two-part design and includes an upper shell 22 and a lower shell 23, which are connected to one another with a detachable connection, for example a screw connection. The upper and lower shells 22, 23 each include a stable frame 24, 26 and are closed off at the top and bottom by a hood 25 and a base plate 27, respectively. In the illustration of FIG. 1, the hood 25 is shown transparent to reveal the components 81 contained in the housing 20. The lower shell 23 has through-holes 75 for media and electrical lines, an entry/exit area 40 for radiation with through-openings 41, 41′, and a connection area 50′ for fixing the housing 20 in a measurement environment.

The housing 20 shown in FIG. 2 is a universal housing in the sense that it can be used for a wide range of different measuring tasks in various process and laboratory environments. Depending on the application, the housing 20 accommodates different measuring arrangements 80 in its interior 21 and is provided with suitable optical and mechanical additional elements which permit coupling/uncoupling of the measuring radiation from the housing 20 and positionally accurate detachable mounting of the housing in the measuring environment.

The frames 24, 26 of the housing 20 have an approximately rectangular shape and are made of a metal, for example stainless steel. The base plate 27 is approximately flat and is attached to the frame 26 of the lower shell 23 with a suitable connection technique, for example with screws, gluing, soldering or welding. The hood 25 of the upper shell 22 is a deep-drawn sheet of stainless steel and is bonded, welded, soldered or otherwise connected to the frame 24 of the upper shell 22. In the assembled position shown in FIG. 2, the two housing shells 22, 23 enclose an interior in the form of a closed cavity 21 in which a measuring arrangement 80 can be completely accommodated. The opposing contact surfaces 28, 28′ of the upper shell 22 and lower shell 23 are configured as approximately flat annular surfaces, between which a circumferential seal 29, for example an O-ring or a flat seal made of plastic or metal, can be arranged. With such a seal 29, the interior 21 of the housing 20 can be hermetically sealed; this is particularly advantageous if the analysis device 10 is to be used in a contaminated or potentially explosive process environment 5.

A component carrier 38, on which the optical and electronic components 81 of the measuring arrangement 80 can be mounted, is located in the interior 21 of the housing 20. The component carrier 38 is detachably attached, for example by a screw connection, to the frame 26 of the lower shell 23 of the housing 20. Such a detachable connection of the component carrier 38 to the lower shell 23 allows the component carrier 38 currently in use to be replaced by another component carrier (of the same or different design), which increases the flexibility and maintainability of the optical analysis device 10. Furthermore, differently equipped component carriers 38 can be used such that the same housing 20 can be used to house different measuring arrangements 80.

The component carrier 38 accommodates all optical, optoelectronic, optomechanical and electronic components 81 of the measuring arrangement 80, such that all individual components 81 required for a given measuring task can be fixed together and in a fixed relative position on the component carrier 38. The housing 20 surrounding the component carrier 38 with the robust frame 26 protects the component carrier 38 and the components 81 located thereon from mechanical interference and provides the measuring arrangement 80 with a high degree of mechanical and thermal stability.

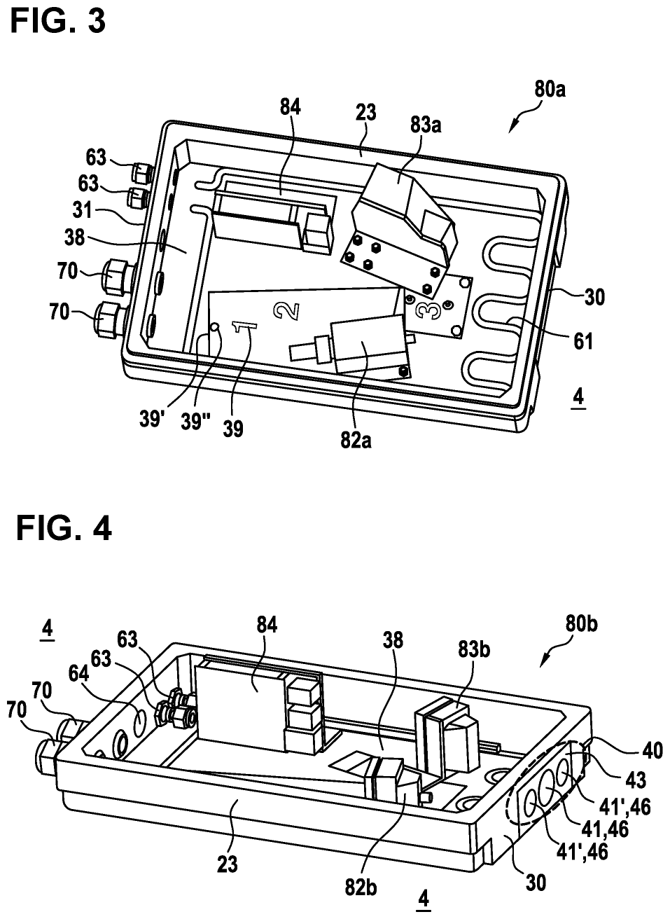

In order to be able to solve a defined measuring or testing task, the associated components 81 must be mounted completely and in a defined position and orientation on the component carrier 38. For correct and reproducible placement of the components 81 at the intended locations on the component carrier 38, the component carrier 38 has a coding 39 (e.g., in the form of lines 39′, outlines, inscriptions etc. of the component carrier surface). An example of such coding 39 is shown in FIG. 3. In particular, the coding 39 contains information on the component type, position and orientation of the respective component 81 etc. for the respective measuring task. Additionally or alternatively, the coding 39 may include mechanical elements such as stops 39″, knobs, detents, which simplify a one-to-one placement and alignment of the components 81. Thus, the coding 39 provides a type of grid that ensures that the component carrier 38 can only accommodate certain combinations of components 81 and that each of these components 81 has its predetermined location and desired orientation. Thus, a single glance at the component carrier 38 is sufficient to verify that all components 81 (radiation source, detector, controller, etc.) required for a particular measurement task have been correctly mounted and that their orientation is correct. This greatly simplifies service and replacement of components 81 and allows good reconfigurability of optical analysis devices 10 for a wide range of applications.

The component carrier 38 can also contain different sets of codes 39 for different applications, such that one and the same component carrier 38—depending on the application—can be equipped with different sets of components 81. In the exemplary embodiment shown in FIG. 3, the component carrier 38 for a spectrometric application in the UV range is equipped with a measuring arrangement 80 including a UV radiation source 82a, a grating spectrometer 83a, and a controller 84. FIG. 4 shows an exemplary embodiment in which the component carrier 38 shown in FIG. 3 has a minimum configuration for a spectrometric application in the mid-IR range (measuring arrangement 80b with radiation source 82b, spectrometer 83b and controller 68). Additionally, there may be other components 81 not shown in FIGS. 3 and 4. Note that the measuring arrangements 80a, 80a shown in FIGS. 3 and 4 can both be fully accommodated within the housing 20 shown in FIG. 2. Thus, while the placement of the component carrier 38 changes depending on the application, the same (universal) housing 20 can always be used for these different applications. The components 81 to be fixed on the component carrier 38 can be selected and combined as desired, depending on the application and the spectral range to be used for the measurement.

Incidentally, such a modular system is also suitable for training purposes: a trainee is provided with a coded component carrier 38 and a broad set of different optical components 81. The trainee then selects those components 81 which, from his point of view, are suitable for solving a given measurement task, arranges them on the component carrier 38 and then tests the resulting measuring arrangement 80. In this way, the trainee can learn the construction of spectrometer measurement systems for different applications in a practical way.

For power supply and external data exchange of the optical, electrical, electro-optical and electromechanical components 81 arranged in the housing 20, in particular on the component carrier 38, electrical connecting elements 70 are provided in the lower shell 23 of the housing 20 for connection of power or signal cables (not shown in the FIGS.). The connecting elements 70 are typically arranged on a side of the housing 20 facing away from the measured object, in particular on a rear side 31. Signal connection and data transmission can be carried out via Ethernet. All common industrial interfaces can be used, for example CAN, Profibus, Modbus, etc. In the interior 21 of the housing 20, the components 81 can be connected to each other or to the connecting elements 70, for example, via cables with standard interfaces (in particular USB connections). This allows a high degree of flexibility in configuring the measuring arrangement 80 and in replacing individual components 81.

In addition to use in a laboratory environment, the housing 20 is particularly suitable for use in a process environment in which high or low ambient temperatures as well as strong temperature fluctuations may be present. In order to protect or shield the measuring arrangement 80 located in the housing 20 from these environmental influences, the housing 20 includes a temperature control device, which is described below as a cooling device 60, but which may just as well be a heating device. The cooling device 60 includes a cooling line 61, which is arranged in a cavity 62 between the base plate 27 of the housing lower shell 23 and the component carrier 38 (see FIG. 2) and through which a fluid cooling medium flows. The cooling medium may be a fluid such as air, water or oil, etc. For connecting the cooling line 61 to a coolant supply (not shown in the FIGS.), two connections 63 are provided—as shown in FIGS. 1 and 3—in the frame 26 of the lower shell 23, which are advantageously located—just like the electrical connecting elements 70—on the rear side 31 of the housing 20 facing away from the measured object. Since the entire cavity 62 located below the component carrier 38 can be used for arranging cooling lines 61, temperature control can be provided over a large area. As schematically shown in FIG. 3, the cooling line 61 has a meandering course, whereby the arrangement and mutual spacing of the individual cooling loops in the cavity 62 are in principle freely configurable and can be configured according to the prevailing working conditions. Thus, one will provide a higher density of loops of the cooling line 61 for measurements in a very hot process environment than in a moderate process environment. Furthermore, one will expediently configure the cooling line 61 such that areas where increased process heat occurs or penetrates are cooled more. Thus, with the aid of the cooling device, a heat or cooling power introduced into the housing from the outside can be effectively removed. Furthermore, the cooling device 60 serves to transport away a heat output generated during operation by the components 81 on the component carrier 38. Due to the form fit, the cooling is also transferred to the component carrier 38 and in this way ensures a high temperature stability in the interior 21 of the housing 20. In order to distribute the cooling power more evenly, a sheet of a material with good thermal conductivity (e.g., copper) can be inserted between the base plate 27 and the cooling line 61 or between the component carrier 38 and the cooling line 61. Furthermore, the cavity 62 formed between base plate 27, component carrier 38 and the outer walls of cooling line 61 can be filled with a thermally conductive bulk material, for example small glass beads, to ensure more uniform heat dissipation.

In addition or as an alternative to the cooling device 60 in the lower shell 23 of the housing 20 shown in FIGS. 2 and 3, the upper shell 22 may also be provided with cooling lines, which are typically arranged in the area of the hood 25. In this case, the upper shell 22 must also have connections for the cooling lines.

In order to dissipate the waste heat of the components 81 on the component carrier 38 as effectively as possible during operation and to avoid thermal fluctuations of the measuring arrangement, the interior 21 of the housing 20 can alternatively or additionally be filled with a thermally conductive bulk material, in particular small glass beads. With this bulk material, the heat generated in the interior space 21 is dissipated to all contacting surfaces. For filling the interior 21, an opening 64 is provided on the rear side 31 of the housing 20, through which—after mounting the measuring arrangement 80 on the component carrier 38 and an optical/electrical connection of the components 81—the bulk material is filled into the interior 21. The opening 64 is then closed, for example with a cover which can be screwed into the opening 64. The closure is advantageously configured such that moisture in the housing interior 21 is prevented or at least detected; for this purpose, a drying element and/or a moisture indicator can be provided.

In addition to improved thermal conductivity, completely filling the interior 21 with a bulk material has the additional advantage of making the optical analysis device 10 resistant to use in a harsh production environment 5, in particular an explosive process environment, in a structurally simple manner. Namely, by filling the cavity in the interior 21 of the housing with small glass beads, the air is displaced from the interior 21 and thus the volume of gas in the housing 20 is greatly reduced, which reduces the risk of deformation of the housing 20 in the event of an explosion.

For the emission and introduction of measuring radiation into the housing interior 21, the housing 20 has three circular through-openings 41, 41′ in the entry/exit area 40 on the front side 30 facing the measured object, one or more of which—depending on the application—are used for the measuring radiation. The unused through-openings are then closed as required to protect the housing interior 21 against ingress of dust, radiation, etc.

If the optical analysis device 10 is used, for example, in a laboratory environment in which a transmission measurement of the measurement medium is to be performed, then a free-beam optics can be implemented using the two lateral openings 41′, in which the measurement beam exits the housing 20 through one of the lateral openings 41′, is guided through the measurement medium, and is then guided back into the housing 20 through the other lateral opening 41′. On the other hand, the central opening 41 can be used, for example, for a free-beam optical system for reflection measurements or for connecting an integrating sphere for generating diffuse radiation.

In addition to the supply and discharge of radiation, the openings 41, 41′ in the entry/exit area 40 can also be used to feed through electrical lines, for example for lines for connecting sensors that record process variables or environmental information of the measured medium. For example, a data line can be provided for transmitting measured temperature values of the measured medium and/or a data line for transmitting measured data of a leakage sensor. Furthermore, control lines may also be provided to exchange control signals between the controller 84 in the interior 21 of the housing and actuators in the exterior 4 of the housing 20, for example to control an automated measurement of the white level. Such data or control lines must be provided with electrical connectors in the area of the entry/exit area 40 to allow easy and quick disconnection of the data line when the optical analysis device 10 is removed from the process environment. More generally, the entry/exit area 40 thus provides an optical, electrical and thermal interface between the interior 21 of the housing and the exterior 4 surrounding the housing 20.

If the optical analysis device 10 is to be used in a process environment, it is advisable to provide a mechanical seal in the entry/exit area 40, for example a window that is transparent to the radiation used, to prevent dust or dirt from entering the interior 21 of the housing 20. For measurements in a process environment, an optical fiber or an optical fiber bundle is advantageously used to guide the measurement radiation. As an optical interface between the interior 21 of the housing 20 and the exterior space 4, the central opening 41 is then advantageously used to couple optical fibers in the interior 21 of the housing and/or exterior 4 to each other via an optical interface. For this purpose, some structural precautions must be taken (collimation of the radiation, coupling/uncoupling into optical fiber bundles or individual fibers, termination windows, etc.). In order to center the lines (optical fibers, electrical lines, etc.) to be connected to the housing 20 from the outside in the central opening 41, the central opening 41 may be provided with a hollow cone-shaped section 45 opening outwardly, as indicated in FIG. 2.

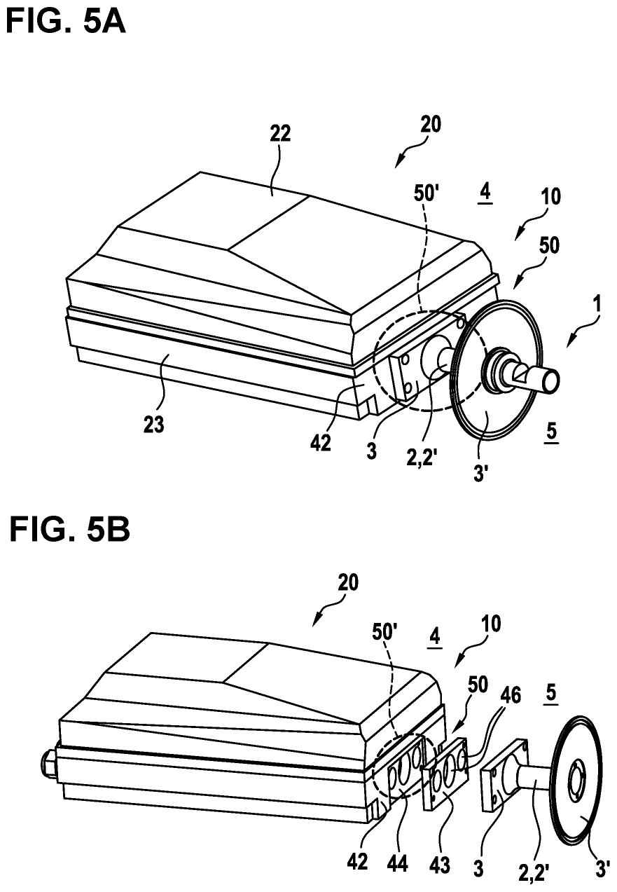

In order to perform reproducible measurements, the optical analysis device 10 must be mechanically attached to a container or environment carrying the measurement medium (e.g., in the case of measurements in a process environment 5, to a process chamber). In the following, this is explained with reference to FIGS. 5A and 5B with the example of an optical analysis device 10 which is to be used for the examination of a measurement medium (not shown in FIGS. 5A and 5B) with the aid of an immersion probe 1 in a process environment 5. For this purpose, a measuring beam is used which is guided with light guides (not shown in the FIGS.) to the central opening 41 of the entry/exit area 40 and from there is guided in the exterior 4 of the housing 20 with further light guides to the immersion probe 1.

To connect the housing 20 of the analysis device 10 to the process environment, a connection component 2 is provided, which is attached to a predetermined measuring point in the process environment 5 and can be detachably attached to a connection area 50′ on the housing 20 via a mechanical interface 50. FIG. 5A shows a perspective view of the optical analysis device 10 in assembled position with connection component 2 and immersion probe 1, FIG. 5B an exploded view explaining the connection of the connection component 2 to the housing 20 of the optical analysis device 10.

To connect the immersion probe 1 to the housing 20 of the optical analysis device 10 shown in FIG. 5A, the connection component 2 has the form of a double flange 2′ with two flange sides 3, 3′. With one of the flange sides 3′, the double flange 2′ is fixed or detachably fixed to a component (not shown in FIG. 5) in the process environment 5. With the other flange side 3, it is detachably fixed to the connection area 50′ of the housing 20, which is located on the front side 30 of the housing 20 facing the measuring object. The connection area 50′ spatially overlaps with the entry/exit area 40 for the measuring radiation. In the exemplary embodiment, the connection area 50′ overlaps the entry/exit area 40 for the measuring radiation, such that the measuring beam is led out of/into the housing 20 in the mechanical connection area 50′. In this entry/exit area 40, the housing 20 has—as described above—several openings 41, 41′, which allow different configurations for mechanical and optical flanging of the housing 20 to connecting components 2 in the process environment. With the help of a suitably configured double flange 2′ (or a suitably shaped connection component 2)—as an alternative to the immersion probe 1 shown in FIG. 5A—other optical probes can also be connected, for example a flow cell, a reflection probe etc. or other investigation instruments for carrying out an analysis in solids, liquids or gases. In the interior of the double flange 2′, optical fibers are routed for the entry/exit of measuring light, as well as electrical connections for sensors (e.g., temperature sensor) and/or actuators. In order to make this connection insensitive to use in a harsh, in particular a potentially explosive, process environment 5, an interior space of the double flange 2′ can be provided with a potting compound.

The flange side 3 of the double flange 2′ facing the optical analysis device 10 contacts an outer wall 42 of the housing 20 in the installation position of the optical analysis device 10 in the process environment 5, as a result of which—especially in a hot or cold process environment 5—there is a risk of undesirable heat or cold entering the housing 20 in this area. In order to protect the temperature-sensitive optical components 81 in the housing 20 of the analysis device 10 against such thermal disturbances, the housing outer wall 42 has a recess 44 in the connection area 50′, for example a milled recess with a reduction in wall thickness, into which a dimensionally stable flat insulation element 43 made of a thermally insulating material (plastic, ceramic, etc.) is inserted. The insulation element 43 provides thermal decoupling of the housing 20 from the connection component 2 and at the same time forms a seal.

Since the connection area 50′ spatially overlaps with the radiation entry/exit area 40, the insulation element 43 spans the area of the three adjacent openings 41, 41′, which serve to realize a large number of measurement situations. In order to be able to use the openings 41, 41′ for radiation that are required for a particular measurement geometry, the corresponding opening 46 (or openings) must also be provided on the insulation element 43; the other openings 41, 41′ that are not required for the measurement geometry can be closed off by the insulation element 43. In the exemplary embodiment, the insulating element 43 has three openings 46 which, in the assembled position of the insulating element 43 with the housing 20, coincide with the openings 41, 41′ of the entry/exit area 40 for radiation; the openings 41′ of the entry/exit area 40 not required for the measurement with immersion probe 1 are in this case closed by the flange side 3 of the connection component 2 facing the housing 20.

For the optical and electrical connection of the measuring arrangement 80 mounted in the housing interior 21 to the sensor system attached to the connection component 2, a suitable adapter (not shown in the FIGS.) is inserted into the opening 41 of the housing lower shell 23 to enable the electrical and optical contacting in the housing interior 21. The connection component 2 has appropriate optical fibers to establish an optical connection to the probe (immersion probe 1, flow cell, cuvette holder, . . . ) and, if necessary, cables to establish an electrical connection.

In particular, the following steps can be taken to separate the housing 20 from the connection component 2 or the calibration device 90:

1. In a laboratory environment:
Lifting the spectrometer
Inserting the analysis device at a predetermined angle
Rotate the analysis device until the bayonet mount engages.
Depositing the spectrometer with the analysis device
Making and testing the optical and electrical connections

2. In a process environment:
Preparation of the spectrometer for installation
Inserting the analysis device at a predetermined angle
Rotate the analysis device until the bayonet mount engages.
Making and testing the optical and electrical connections
Securing the connection via one to four screw connections
Installation of the spectrometer with the analysis device at the analysis site

For releasable mechanical fastening of the housing 20 to the connection component 2, the housing 20 has a fastening element 51 in the connection area 50′, which interacts with a counter element 52 of the connection component 2 to create a positive and non-positive releasable connection between the housing 20 and the connection component 2. The fastening element 51 and the counter element 52 create a mechanical interface 50 which is configured to allow the housing 20 to be removed from the measuring position in the process environment 5 in a simple manner (e.g., to perform a validation of the optical analysis device) and to be mounted again in the process environment 5 in the exact position just as easily. Furthermore, the housing 20 can be mechanically fixed in different measurement environments with the fastening element 51, provided that a counter element 52 is fastened in the respective measurement environment. The mechanical interface 50 with the fastening elements 51, 52 is thus universal in the sense that it allows the housing 20 (and thus the optical analysis device 10) to be mechanically fixed in a precise position to different devices and equipment in both a laboratory environment and a process environment.

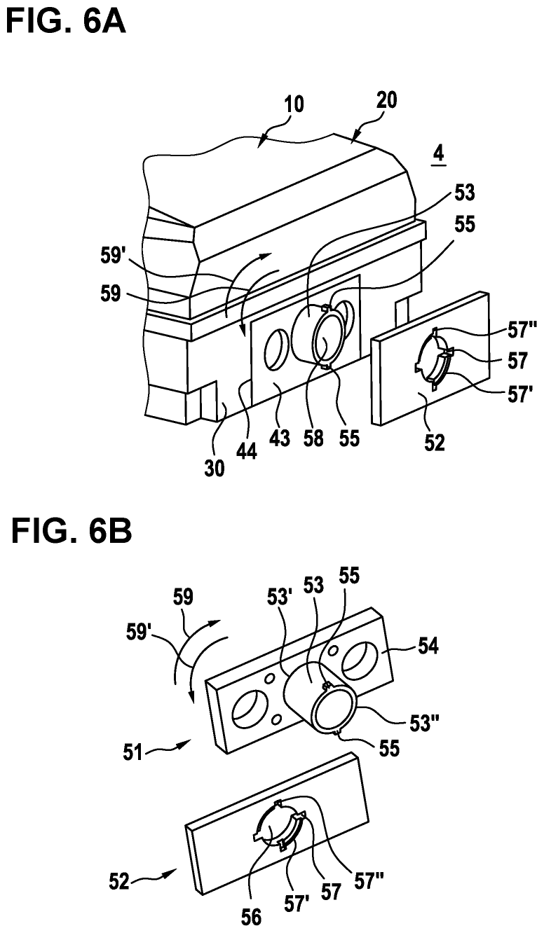

In the exemplary embodiment shown in FIGS. 6A and 6B, a connection of the housing 20 to the connection component 2 is shown with a bayonet mount. FIG. 6B shows a perspective view of a fastening element 51 with associated counter element 52; FIG. 6A shows a view of the connection area 50′ of the housing 20 with fastening element 51 and counter element 52. The fastening element 51 to be fastened to the housing 20 includes a tubular section 53, one end 53′ of which is provided with a connecting plate 54 to be fastened to the housing 20 and the opposite end 53″ of which has two outwardly projecting projections 55. The counter element 52 to be attached to the connecting component 2 is in the form of a flat plate with a circular through opening 56; the through opening 56 is provided with two continuous longitudinal slots 57, adjoined by transverse slots 57′. The connection is made by a plug-and-rotate motion: The fastening element 51 is rotated by 90 degrees (arrow 59) and inserted with the tubular section 53 through the through opening 56 of the counter element 52. The fastening element 51 is then rotated 90 degrees in the opposite direction (arrow 59′). The depth of the transverse slots 57′ varies in the plane perpendicular to the direction of insertion, which is why the rotary movement 59′ presses both parts 51, 52 against each other. Indentations 57″ at the end of the transverse slots 57′ act as detents to secure the connection. In this way, the optical analysis device 10 with the fastening element 51 provided in the housing 20 can be fixed to the counter element 52 (fastened at a predetermined location in the production environment 5) by a simple rotation through 90 degrees and can be released again just as easily by a counter-rotation through 90 degrees.

Such a bayonet mount thus enables a positionally and angularly accurate detachable connection between the housing 20 and the connection component 2. This connection can be made very quickly by inserting the fastening element 51 of the housing 20 into the counter element 52 attached to the connection component 2 and locking it in place by a 90-degree turn. When the optical analysis device 10 is used in a process environment, the connection between the housing 20 and the connection component 2 can be additionally secured by screws. If the optical analysis device 10 is used in a laboratory environment, then an arrangement on a common support, for example on a table, is sufficient to secure the connection.

The fastening element 51 may be attached to the outer wall 42 of the housing lower shell 23 or also to the insulation element 43. In the exemplary embodiment shown in FIGS. 5A to 6B, the fastening element 51 is configured such that its connecting plate 54 is fastened in the housing interior 21 and the tubular section 53 protrudes outward through the opening 41 provided for the entry/exit of radiation 40. Thus, the entry/exit of radiation occurs through an interior 58 of the tubular section 53. Alternatively, the connecting plate 54 may also be attached to the outer wall 42 of the housing 20, in particular also to the insulating element 43 provided in the recess 44 in the housing outer wall 42.

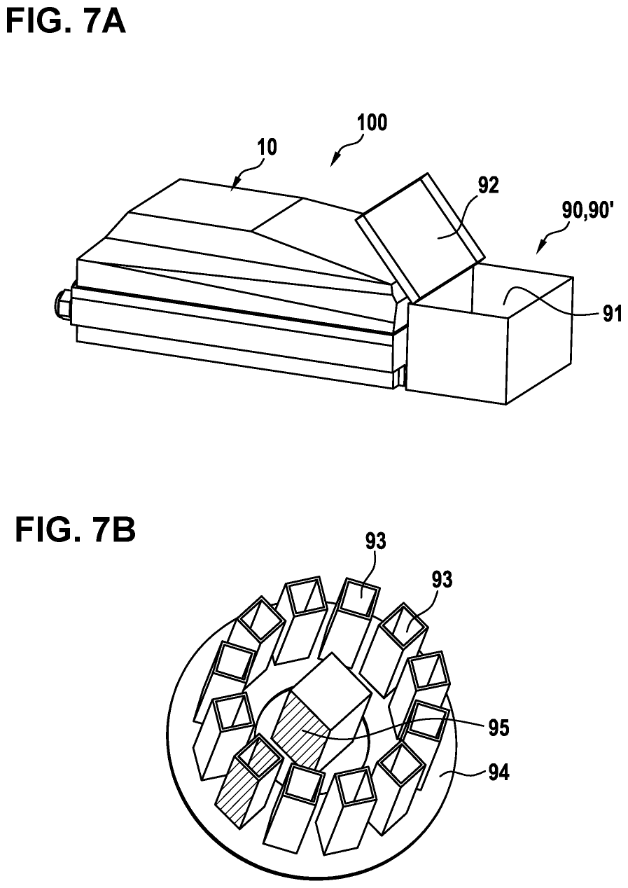

To ensure reproducible absolute measurements, it is necessary to validate or calibrate the optical analysis device 10 at regular intervals. This is done with the aid of a calibration device 90 in a laboratory environment. To perform such validation/calibration, the optical analysis device 10 is removed from the process environment 5 and connected to the calibration device 90. This is shown in FIG. 7A, which shows a perspective view of the optical analysis device 10 in assembled position with a calibration device 90 configured, for example, as a carousel system 90′ (a linear arrangement is also possible) with the lid 92 open. The calibration device can be manual or automated. To connect the analysis device 10 to the calibration device 90, the same detachable mechanical interface 50 is used with which the optical analysis device 10 was previously fixed in the process chamber 80. In the exemplary embodiment, in which the mechanical interface 50 is implemented by a bayonet mount, a counter element (not shown in FIG. 7A) is provided on the calibration device 90, which corresponds in terms of its functionality and configuration to the counter element 52 shown in FIG. 6B. This counter element interacts with the fastening element 51 of the housing 20 to provide a quick and reproducible connection between the calibration device 90 and the optical analysis device 10. This bayonet mount therefore allows the optical analysis device 10 to be not only quickly and easily detached from the process environment 5, but also quickly, easily and reproducibly attached to the calibration device 90.

The optical analysis device 10 and the calibration device 90 together represent a system 100 which, on the one hand, enables a measurement of a measurement medium in a process environment 5 and, on the other hand, permits a fast and simple validation or calibration of the optical analysis device 10. For validation or calibration, the analysis device 10 is connected to the calibration device 90 via the mechanical interface 50, which includes a sample chamber 91 that can be closed with a lid 92. The mechanical interface 50 allows the optical analysis device 10 to be held in a positionally accurate and immovable manner (with or without thermal decoupling by an insulation element 43) on the calibration device 90. The mechanical interface 50 ensures that the individual components of the optical analysis device 10 and the calibration device 90 are in a defined arrangement to each other.

The sample chamber 91 contains standard measurement objects, in particular cuvettes 93, which are used to perform the validation/calibration. In the present example, a carousel system 90′ with a plurality of cuvettes 93 arranged on a turntable 94 is used. FIG. 7B shows a schematic representation of such a turntable 94 equipped with several samples, in the center of which an optical mirror 95 is located.

If validation of the optical analysis device 10 is to be performed, the sample turntable 94 is loaded with a set of predetermined standard cuvettes 93 and inserted into the interior 92 of the carousel system 90′. Radiation from the optical analysis device 10 is directed into the calibration device 90, passes through one of the cuvettes, and is reflected by the mirror 95 back into the optical analysis device 10. In the course of the validation process, each of the standard cuvettes 93 is gradually brought into a measuring position and measured by rotating the turntable 94. The measurement geometry corresponds exactly to that used during the measurements in the process environment 5. In this way, the analysis device 10 can be automatically validated. Alternatively, instead of the turntable 94, a cuvette bar with a linear arrangement of the standard measurement objects 93 or a cuvette holder for holding a single standard cuvette 93 can be used.

Furthermore, the system 100 shown in FIG. 7A can also be used in a laboratory environment, for example to measure multiple samples 93 of a similar substance (which may have been obtained under different conditions), which are inserted into the turntable 94 and measured in sequence.

Due to the modular optical and mechanical interfaces 40, 50 of the housing 20, the described optical analysis device is suitable for use in a variety of spectral and photometric methods in a wide range of application environments in the process environment and in the laboratory.

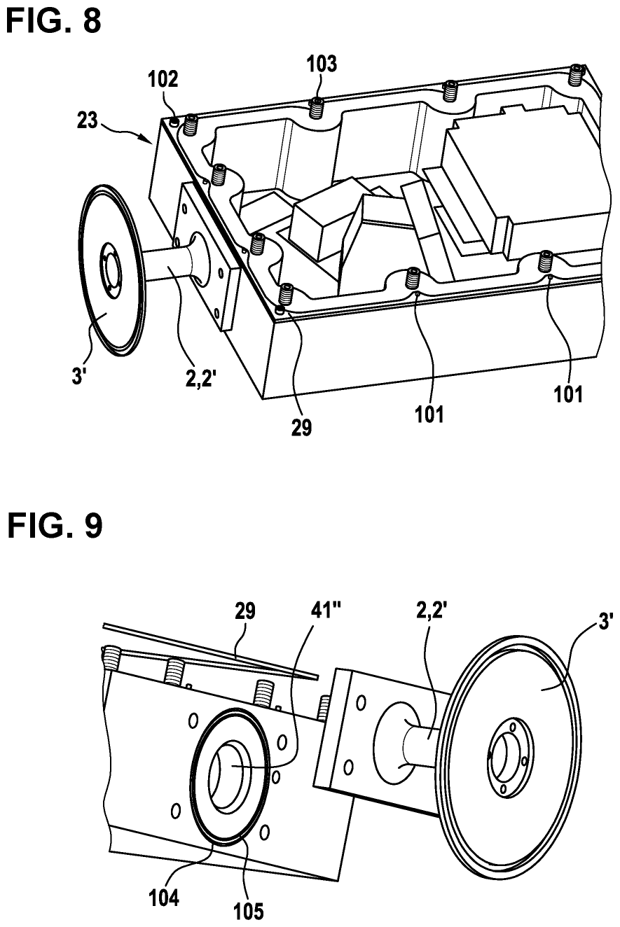

The sealing concept of the analysis device 10 according to an aspect of the disclosure is illustrated with the exemplary embodiment shown in FIG. 8. The concept of forming the walls of the housing, in the exemplary embodiment shown, of the lower shell 23, with such a thickness that when the lower shell 23 is joined to the upper shell not shown in FIG. 8, an area results in which metal rests on metal and which has a gap length of at least 12.5 mm. In this way it is ensured that even in the event of explosions in the interior no flames escape in the direction of the exterior of the housing. Also shown in FIG. 8 are through bolts 103, with which the upper shell is bolted to the lower shell 23. For a further improvement of the tightness against dust, gases or also liquids, the seal 29 is present, which is secured against loss at the corners of the lower shell 23 in each case by a locking screw 102. The seal 29 is secured against lateral displacement with the locking pins 101, which can also be seen in FIG. 8. It goes without saying that, in addition to the threaded holes for the through bolts 103, recesses must be provided in the top shell to accommodate the screw heads of the locking screws 102 as well as to accommodate the locking pins 101 to ensure the tightness of the housing.

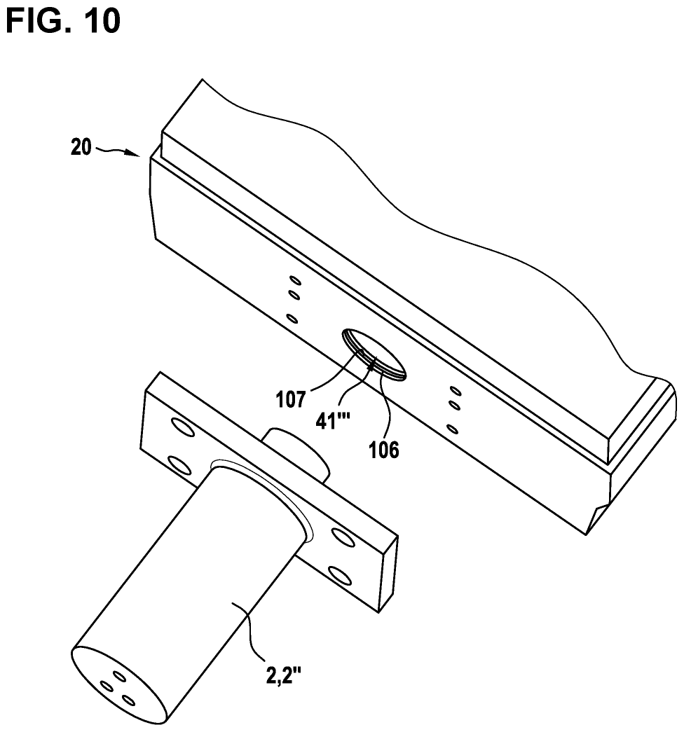

FIG. 9 shows a further detail of the sealing concept of the analysis device 10 according to an exemplary embodiment of the disclosure. In this case, the opening 41″ is surrounded at a corresponding distance, which can be 12.5 mm or more, for example, by a seal 105 in the form of an O-ring arranged in an annular groove 104. Thus, the required specifications for explosion protection are also met in this case.

FIG. 10 shows an exemplary embodiment of the sealing concept for cases in which a connection to a sample chamber is established via a nozzle not designated in FIG. 10, which is inserted into the opening 41′″. In the example shown, the opening 41′″ has a recess 107 on its inner circumferential side, into which a seal 106, which in the example shown is designed as an O-ring, is inserted.

It is understood that the foregoing description is that of the exemplary embodiments of the disclosure and that various changes and modifications may be made thereto without departing from the spirit and scope of the invention as defined in the appended claims.

### LIST OF REFERENCE NUMERALS

1 Immersion probe
2 Connection component, 2′ double flange
3, 3′ Flange side
4 Exterior, outdoor space
5 Process environment
10 Optical analysis device
20 Housing
21 Interior of the housing
22 Upper shell
23 Lower shell
24 Frame
25 Hood
26 Frame
27 Base plate
28, 28′ Contact surface
29 Seal
30 front side of the housing 20 facing the measuring object
31 rear side of the housing 20 facing away from the measured object
38 Component carrier
39 Coding 39′ Lines 39″ Stop
40 Entry/exit area for radiation
41, 41′,41″,41′″ Opening for radiation
42 Outer wall
43 Flat insulation element=intermediate plate
44 Recess
45 Hollow cone section
46 Opening on flat insulation element 43
50 Mechanical interface
50′ Connection area
51 Fastening element
52 Counter element
53 tubular section with ends 53′, 53″
54 Connecting plate
55 Projections protruding outward
56 Through opening in the counter element
57 Longitudinal slots 57′ Transverse slots 57″ Indentations
58 Interior tubular section
59 Arrow rotation
60 Cooling device
61 Cooling line
62 Cavity between component plate and base plate
63 Connection for cooling line
64 Opening on rear side of housing for filling the interior
70 Connecting element
75 Through holes
80 Measuring arrangement
81 Components
82 Radiation source
83 Detector 83′ Spectrometer
84 Controller
90 Calibration device
90′ Carousel system
91 Sample chamber
92 Lid
93 Cuvette
94 Turntable
95 Mirror
100 System
101 Locking pin
102 Locking screw
103 Through bolt
104 Annular groove
105 Seal
106 Seal
107 Recess

What is claimed is:

1. An optical analysis device for determining at least one characteristic of a medium, the optical analysis device comprising:
a housing having at least one entry/exit area for an entry and/or an exit of optical radiation; and
an optical measuring arrangement with a plurality of components arranged in an interior space of the housing,
wherein the housing has a mechanical interface configured to positionally accurate detachably mount the optical analysis device at a location of operation in a process environment.

2. The optical analysis device according to claim 1, wherein the mechanical interface is arranged in a connection area of the housing which spatially overlaps with the at least one entry/exit area.

3. The optical analysis device according to claim 1, wherein the components of the optical measuring arrangement are arranged together on a component carrier in the interior of the housing.

4. The optical analysis device according to claim 3, wherein the component carrier is detachably attached in the interior of the housing.

5. A housing for components of a measuring arrangement for optical determination of at least one characteristic of a medium, the housing comprising:
a component carrier configured to mount the components; and
at least one entry/exit area for entry and/or exit of optical radiation,
wherein the housing has a mechanical interface configured to positionally accurate detachably attach of the housing at a location of operation to an outer wall of a process chamber.

6. The housing according to claim 5, wherein the mechanical interface includes fastening elements, and
wherein at least one of the fastening elements is fastened in a connection area of the housing.

7. The housing according to claim 5, wherein the mechanical interface is a bayonet mount.

8. The housing according to claim 6, wherein the connection area and the at least one entry/exit area spatially overlap.

9. The housing according to claim 5, wherein the component carrier is fixed in a closed inner space of the housing.

10. The housing according to claim 5, wherein the housing has at least two parts and includes an upper shell and a lower shell.

11. The housing according to claim 10, wherein a seal is provided between the upper shell and the lower shell.

12. The housing according to claim 11, wherein the seal is secured against loss with locking screws.

13. The housing according to claim 11, wherein the seal is secured against slipping with locking pins.

14. The housing according to claim 5, wherein the housing includes a cooling device.

15. The housing according to claim 14, wherein the cooling device is arranged in a cavity formed between the component carrier and a base plate of the housing in the interior of the housing.

16. The housing according to claim 14, wherein the cooling device includes a cooling line through which a cooling medium can flow.

17. The housing according to claim 14, wherein the cooling device is configured such that a cooling medium first reaches at least one of the components and subsequently reaches the at least one entry/exit area for the entry/exit of optical radiation.

18. The housing according to claim 5, wherein the component carrier has a coding for positionally and/or angularly accurate positioning of the components to be arranged thereon.

19. A system for determining at least one characteristic of a medium in a process chamber, the system comprising:
an optical analysis device according to claim 1, which can be detachably attached at the location of operation in the process chamber; and
a calibration device,
wherein an interface provided on the housing of the optical analysis device enables the optical analysis device to be attached to the calibration device in a positionally accurate and detachable manner.

20. The system according to claim 19, wherein to establish the detachable connection between the calibration device and optical analysis device, a fastening element provided on the housing of the optical analysis device engages in a counter element fastened to the calibration device.

21. The system according to claim 19, wherein the detachable connection between the calibration device and the optical analysis device is formed by a bayonet mount.
